(19) United States
(12) Patent Application Publication
(10) Pub. No.: US 2017/0145984 A1
(43) Pub. Date: May 25, 2017

(54) WAVE MOTOR AND DESALINATION SYSTEM

(71) Applicant: EcoH2O Innovations LLC, Charlotte, NC (US)

(72) Inventors: Christopher W. Matthews, Greenville, NC (US); D. Justin Sonnett, Wilmington, NC (US)

(73) Assignee: EcoH2O Innovations LLC

(21) Appl. No.: 15/352,978

(22) Filed: Nov. 16, 2016

Related U.S. Application Data
(60) Provisional application No. 62/258,802, filed on Nov. 23, 2015.

(51) Int. Cl. F03B 13/18; B01D 61/02; B01D 61/10; C02F 1/44

(52) U.S. Cl. CPC F03B 13/1885; C02F 1/441; B01D 61/025; B01D 61/10; F05B 2220/706; F05B 2240/93; F05B 2260/502; C02F 2103/08

(57) ABSTRACT

Wave energy is utilized by and/or seawater is desalinated by a point-absorber-type wave energy converter has: an anchor affixed to an ocean floor, a buoy is tethered to the anchor, and a machine is located on the buoy; the buoy includes a spool system and a recoil system, the spool system has a first spool and a second spool mounted together on a shaft, the recoil system includes a spring, a first line connects the first spool and the anchor, so that as the wave displaces the buoy, the shaft turns and drives the machine, and a second line connects the second spool and the recoil system, so that after the displacement of the buoy, the first line is recoiled onto the first spool.

### RELATED APPLICATION

This application claims the benefit of co-pending U.S. Provisional Application Ser. No. 62/258,802 filed Nov. 23, 2015, which is incorporated herein by reference.

### FIELD OF THE INVENTION

The invention is directed to a wave motor and a desalination system using the wave motor.

### BACKGROUND OF THE INVENTION

Wave energy is a renewable energy source. Capture of that energy and utilizing that captured energy is an ongoing effort. Some solutions to the capture and utilization of wave energy are not suitable for use in remote areas. There is a need for a simple, non-capital intensive, and portable system for capturing and using wave energy.

In some areas of the world, potable water is not available nor is the energy necessary to produce that potable water. There is a need for a simple, non-capital intensive, and portable system for desalinating seawater to potable water.

### SUMMARY OF THE INVENTION

Wave energy is utilized by and/or seawater is desalinated by a point-absorber-type wave energy converter having: an anchor affixed to an ocean floor, a buoy is tethered to the anchor, and a machine is located on the buoy; the buoy includes a spool system and a recoil system, the spool system has a first spool and a second spool mounted together on a shaft, the recoil system includes a spring, a first line connects the first spool and the anchor, so that as the wave displaces the buoy, the shaft turns and drives the machine, and a second line connects the second spool and the recoil system, so that after the displacement of the buoy, the first line is recoiled onto the first spool.

### DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a schematic illustration of the instant invention.

FIG. 2 is a schematic illustration of the instant invention.

FIG. 3 is a schematic illustration of an embodiment of the spool system of the instant invention.

FIG. 4 is a schematic illustration of an embodiment of the recoil system.

FIG. 5 is a schematic illustration of another embodiment of the recoil system.

FIG. 6 is a schematic illustration of the instant invention used as a desalinator.

### DESCRIPTION OF THE INVENTION

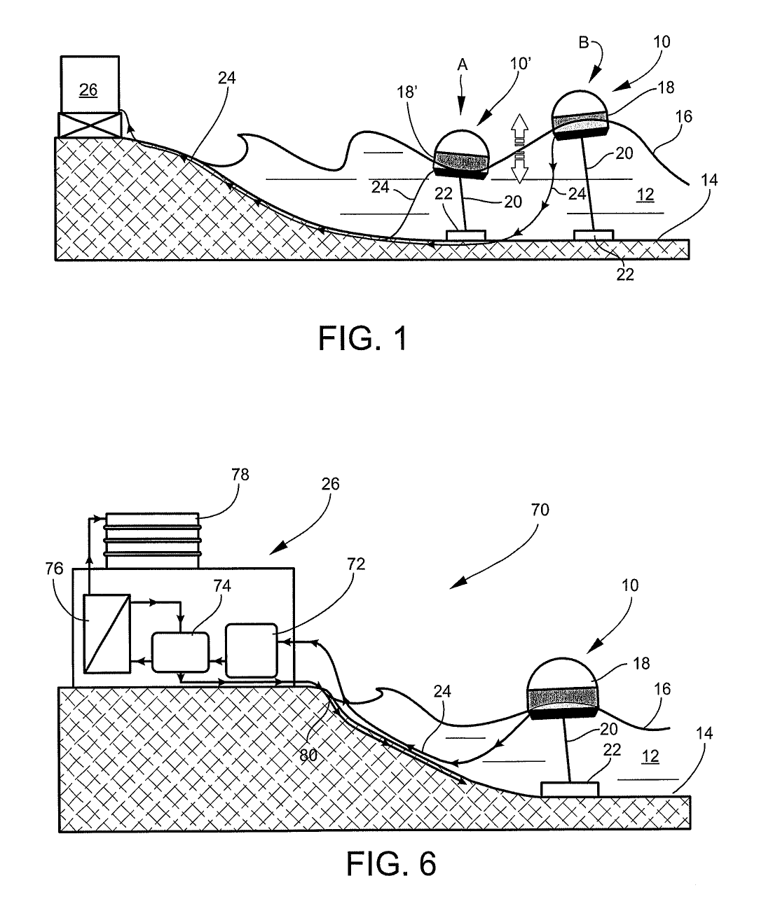

Referring the drawings, wherein like numerals indicate like elements, there is shown in FIG. 1 an embodiment of the wave motor 10. Wave motor 10 floats on ocean 12 and is anchored to the ocean floor 14 via an anchor line 20 connected to an anchor 22 (discussed in greater detail below). FIG. 1 shows that multiple wave motors 10 and 10′ may be used together. Waves 16 displace (or move) the wave motor 10 in a generally vertical direction (see arrow in FIG. 1). As the wave moves the wave motor up and down, the wave energy is captured. This wave motor is referred to, in the industry, as point-absorber-type wave energy converter. A connector line 24 connects the wave motor 10 with a land-based receiver 26. The connector line 24 may convey any item; such items may be compressed seawater, electricity, and/or compressed air.

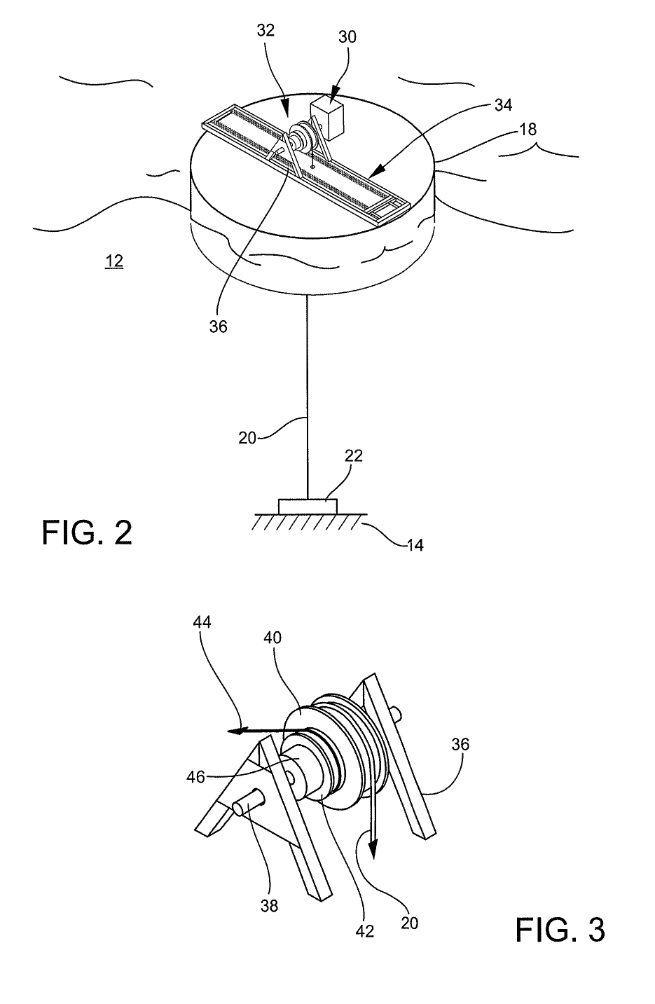

In FIGS. 2-5, the wave motor 10 is illustrated (with the cover removed). The wave motor 10 generally includes: an anchor 22 affixed to an ocean floor 14, a buoy 18 is tethered to the anchor 22, and a machine 30 is located on the buoy 18. The buoy 18 generally includes a spool system 32 and a recoil system 34. Each of the foregoing will be discussed in greater detail below.

In one embodiment (see FIG. 2), each buoy 18 carries a single machine 30, a single spool system 32, and a single recoil system 34. This embodiment is a simple, non-capital intensive, and portable system.

Anchor 22 may be any anchor with sufficient weight to keep the buoy 18 from drifting. Anchor 22 may be placed on and/or rests on and/or is affixed to the ocean floor 14. Anchor 22 may be a single weight, a plurality of weights, a device driven into the ocean floor 14, or a combination thereof.

Buoy 18 is a floating body of sufficient size to carry the machine 30, the spool system 32, and the recoil system 34. Buoy 18 may be any floating body. The buoy 18 may have a cover to protect elements carried thereon.

Machine 30 may be any machine. Machine 30 translates the captured wave energy into a useable form. In one embodiment, machine 30 is a shaft driven machine. Machine 30 may be a pump, an electrical generator, or a compressor (e.g., a gas compressor), or a combination thereof. In one embodiment the pump may be a peristaltic pump. In the desalination embodiment, the machine may be a pump; and the pump may be a peristaltic pump.

Spool system 32 is carried on the buoy 18. In one embodiment, the spool system 32 may be held on the buoy 18 via a frame 36. In the embodiment shown in FIGS. 2-3, the frame 36 may be an A frame. A shaft 38 may be journalled in the frame 18. In the embodiment shown, shaft 38 is positioned above the upper surface of the buoy 18. Shaft 38 is operatively associated, in any conventional fashion, with machine 30. Operatively associated, as used herein, may mean: the shaft is directly coupled with the machine, or the shaft is coupled with the machine 30 via a chain or belt (not shown), or the shaft may be coupled to the machine via a crank arm or crank arm with hydraulic cylinder(s) (not shown), or the shaft is coupled to the machine via a spring system (to store and evenly provide mechanical energy), e.g., a coil or helical spring (not shown), or the shaft is coupled to the machine via a transmission, or combinations thereof.

Spool system 32 further includes a first (or anchor line) spool 40 and a second (or recoil line) spool 42. The first spool 40 and the second spool 42 may be affixed to shaft 38, so that in one rotational direction (as wave 16 lifts buoy 18), shaft 38 drives machine 30, and in the other rotational direction (as wave 16 lowers buoy 18), anchor line 20 is recoiled onto the first spool 40. The first spool 40 may be wrapped with the anchor line 20, so that as the wave 16 lifts buoy 18, shaft 38 drives machine 30. The second spool may be reverse wrapped with a recoil line 44, which is operatively connected with the recoil system 34, so that energy is stored in the recoil system 34 for recoiling the anchor line 20.

Spool system 32 may also include a clutch 46 for engaging the machine while the wave energy is being captured (i.e., buoy lifting), but disengaging (e.g., free spinning) while recoiling (i.e., buoy lowering). In the embodiment shown, clutch 46 is coaxial with shaft 38. Clutch 46 may be any type of clutch. In one embodiment, clutch 46 is for single direction power transmission.

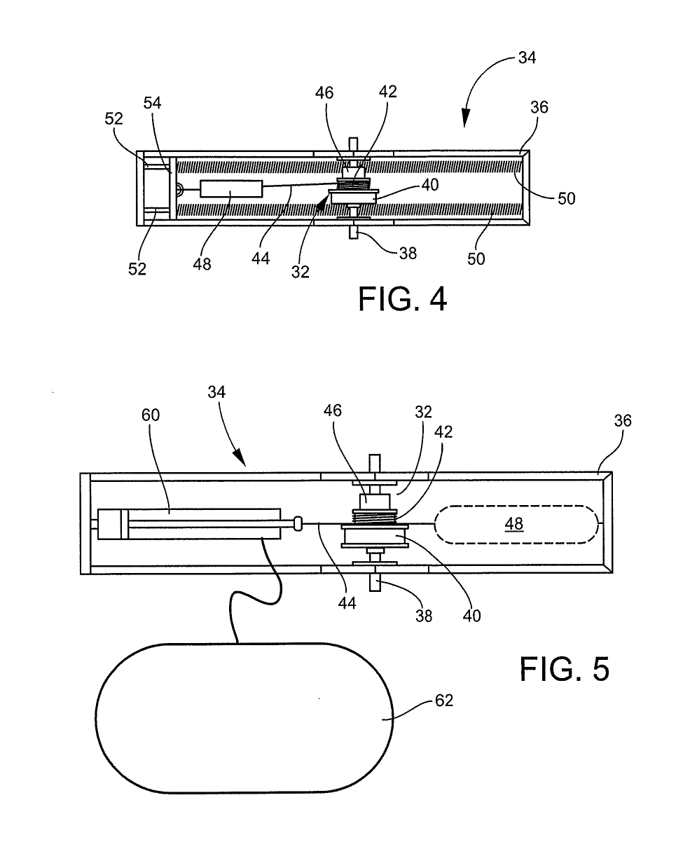

Recoil system 34 is carried on buoy 18. Recoil system 34 recoils anchor line 20 onto the first spool 40. Recoil system 34 includes a spring, but may exclude any counterweight (for example see US2009/0212562, incorporated herein by reference) and/or retraction buoy (for example see US2009/0212562, incorporated herein by reference) and/or a torsion spring around the shaft for recoiling the anchor line on the first spool. The spring may be a mechanical (or linear or compression—i.e., energy is stored as the spring compresses) spring (FIG. 4) and/or an air spring (FIG. 5). The recoil line 40 may be interconnected to the spring with a pulley system 48. The pulley system 48 allows a substantial increase in the amount (i.e., length) of line which can pass through the recoil system given the space allowed for movement of the spring.

The embodiment of the recoil system 34, shown in FIG. 4, uses a mechanical spring 50 (while two springs 50 are shown, and number of these springs may be used and the invention is not limited to the system shown). Spring 50 may be at any angle to shaft 38 (e.g., 90°, 0° or 180°, or any angle therebetween). In the embodiment shown, spring 50 may be generally perpendicular with shaft 38, surround rail 52, is fixed to frame 36 at one end, and is affixed to a traveler 54 at the other end. One end of recoil line 40 is interconnected to the traveler 54 via pulley system 48. As anchor line 20 is paid out (buoy is lifted), recoil line 40 is wound on the second spool and spring 50 is compressed. Once, the buoy starts to cycle down on the wave, the clutch disengages, the compressed spring releases, and the anchor line is recoiled on the first spool.

The embodiment of the recoil system 34, shown in FIG. 5, uses an air spring 60 instead of the mechanical spring 50. The air spring 60 includes an air cylinder 62, which may be pre-charged and periodically recharged, and/or filled by a compressor operated of the wave motor 10.

In operation (see FIG. 1), the wave motor 10 moves from position A (generally—bottom dead center or wave trough) to position B (generally—top dead center or wave crest). At position A (as the wave begins to lift wave motor 10), the anchor line is wound on the first spool, the recoil line is out, and the recoil spring is relaxed. As the wave lifts the wave motor (movement from A to B), the clutch is engaged, the anchor line is paid off the first spool, the machine is driven, the recoil line is wound on the second spool, and the recoil spring stores potential energy. At position B, the anchor line is wound off the first spool, machine driving stops, the recoil line is wound on the second spool, and the recoil spring is energized. As the wave lowers the wave motor (movement from B to A), the clutch is disengaged, the recoil spring releases the potential energy, the recoil line is paid off the second spool, the anchor line rewinds onto first spool, and the machine is not driven. Thereafter the cycle is repeated.

In FIG. 6, an embodiment of the desalination unit (or desalinator) 70 is shown. Desalination unit 70 may be any type of desalinator. In the embodiment shown, the desalinator is a reverse-osmosis (RO) desalinator. The machine 30 is a pump. Seawater is pumped from the wave motor 10 via line 24 to a land based desalination unit 26. The desalination unit 26 generally includes: a filter (not shown), a pressurized tank 72, a control unit (not shown), an energy recovery device 74, a desalination unit 76, a potable water storage tank 78, and a brine discharge line 80.

In operation of the desalination unit 26, seawater is pumped to unit 26, filtered (to remove debris or other contaminants that may foul desalinator 76—e.g., one or more cartridge filters), and is stored, under pressure (e.g., 50-250 psig), in pressurized tank 72. Once, the pressurized seawater in tank 72 reaches a predetermined set point (e.g., a pressure or volume), the control unit discharges the pressurized seawater to desalination unit 76. In one embodiment, the pressurized seawater may be passed through the energy recovery unit 74, which uses the pressured brine discharge from desalination unit 76 to increase seawater pressure into desalination unit 76. The desalination unit 76 may be any desalinator. In one embodiment, the desalination unit 76 may be a reverse-osmosis unit. Potable water from the desalination unit is stored in tank 80 and brine is discharged, via line 80.

The present invention may be embodied in other forms without departing from the spirit and the essential attributes thereof, and, accordingly, reference should be made to the appended claims, rather than to the foregoing specification, as indicating the scope of the invention.

We claim:

1. A point-absorber-type wave energy converter for converting a wave's energy into a usable energy form comprises:
an anchor affixed to an ocean floor, a buoy is tethered to the anchor, and a machine is located on the buoy;
the buoy includes
a spool system and a recoil system, the spool system has a first spool and a second spool mounted together on a shaft, the recoil system includes a spring,
a first line connects the first spool and the anchor, so that as the wave displaces the buoy, the shaft turns and drives the machine, and
a second line connects the second spool and the recoil system, so that after the displacement of the buoy, the first line is recoiled onto the first spool.

2. The point-absorber-type wave energy converter of claim 1 wherein the spring is perpendicularly disposed to the first line.

3. The point-absorber-type wave energy converter of claim 1 wherein the spring is a mechanical spring and/or an air spring.

4. The point-absorber-type wave energy converter of claim 1 wherein the machine is a pump, and/or a generator, and/or a compressor.

5. The point-absorber-type wave energy converter of claim 1 wherein the recoil system excludes any counterweight and/or retraction buoy and/or torsion spring around the shaft for recoiling the first line on the first spool.

6. The point-absorber-type wave energy converter of claim 1 wherein the converter generates energy during wave displacement, but not during recoil of the first line.

7. A seawater desalination unit operated with wave energy comprises:
a wave motor includes
an anchor affixed to an ocean floor, a buoy is tethered to the anchor, and a seawater pump is located on the buoy;
the buoy includes
a spool system and a recoil system, the spool system has a first spool and a second spool mounted together on a shaft, the recoil system includes a spring,
a first line connects the first spool and the anchor, so that as the wave displaces the buoy, the shaft turns and drives the machine, and
a second line connects the second spool and the recoil system, so that after the displacement of the buoy, the first line is recoiled onto the first spool; and
a desalinator operatively associated with the seawater pump.

8. The seawater desalination unit of claim 7 wherein the spring is perpendicularly disposed to the first line.

9. The seawater desalination unit of claim 7 wherein the spring is a mechanical spring and/or an air spring.

10. The seawater desalination unit of claim 7 wherein the recoil system excludes any counterweight and/or retraction buoy and/or torsion spring around the shaft for recoiling the first line on the first spool.

11. The seawater desalination unit of claim 7 wherein the converter generates energy during wave displacement, but not during recoil of the first line.

12. A method of desalinating seawater using wave energy comprises the steps of:
providing a seawater desalinator includes a wave motor has an anchor affixed to an ocean floor, a buoy is tethered to the anchor, and a seawater pump is located on the buoy; the buoy includes a spool system and a recoil system, the spool system has a first spool and a second spool mounted together on a shaft, the recoil system includes a spring, a first line connects the first spool and the anchor, so that as the wave displaces the buoy, the shaft turns and drives the seawater pump, and a second line connects the second spool and the recoil system, so that after the displacement of the buoy, the first line is recoiled onto the first spool; and a desalinator operatively associated with the seawater pump;
placing the desalinator in an ocean;
allowing the waves to displace the desalinator; and
generating potable water from the seawater passing through the desalinator.

13. The method of claim 12 wherein the spring is perpendicularly disposed to the first line.

14. The method of claim 12 wherein the spring is a mechanical spring and/or an air spring.

15. The method of claim 12 wherein the recoil system excludes any counterweight and/or retraction buoy and/or torsion spring around the shaft for recoiling the first line on the first spool.

16. The method of claim 12 wherein the converter generates energy during wave displacement, but not during recoil of the first line.
